(19) United States
(12) Patent Application Publication
(10) Pub. No.: US 2014/0006585 A1
(43) Pub. Date: Jan. 2, 2014

(54) Providing Mobility in Overlay Networks

(71) Applicant: Futurewei Technologies, Inc., Plano, TX (US)

(72) Inventors: Linda Dunbar, Plano, TX (US); T. Benjamin Mack-Crane, Downers Grove, IL (US)

(21) Appl. No.: 13/932,850

(22) Filed: Jul. 1, 2013

Related U.S. Application Data
(60) Provisional application No. 61/666,569, filed on Jun. 29, 2012.

(51) Int. Cl. H04L 12/24

(52) U.S. Cl. CPC H04L 41/00
USPC 709/223

(57) ABSTRACT

A method of managing local identifiers (VIDs) in a network virtualization edge (NVE), the method comprising discovering a new virtual machine (VM) attached to the NVE, reporting the new VM to a controller, wherein there is a local VID being carried in one or more data frames sent to or from the new VM, and wherein the local VID collides with a second local VID of a second VM attached to the NVE, and receiving a confirmation of a virtual network ID (VNID) for the VM and a new local VID to be used in communicating with the VM, wherein the VNID is globally unique.

### CROSS-REFERENCE TO RELATED APPLICATIONS

The present application claims benefit of U.S. Provisional Patent Application No. 61/666,569 filed Jun. 29, 2012 by Linda Dunbar, et al. and entitled “Schemes to Enable Mobility in Overlay Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Virtual and overlay network technology has significantly improved the implementation of communication and data networks in terms of efficiency, cost, and processing power. In a data center network or architecture, an overlay network may be built on top of an underlay network. Nodes within the overlay network may be connected via virtual and/or logical links that may correspond to nodes and physical links in the underlay network. The overlay network may be partitioned into virtual network instances (e.g. virtual local area networks (VLANs)) that may simultaneously execute different applications and services using the underlay network. Further, virtual resources, such as computational, storage, and/or network elements may be flexibly redistributed or moved throughout the overlay network. For instance, hosts and virtual machines (VMs) within a data center may migrate to any server with available resources to run applications and provide services. Technological advances that allow increased migration or that simplify migration of VMs and other entities within a data center are desirable.

### SUMMARY

In one embodiment, the disclosure includes a method of managing local identifiers (VIDs) in a network virtualization edge (NVE), the method comprising discovering a new virtual machine (VM) attached to the NVE, reporting the new VM to a controller, wherein there is a local VID being carried in one or more data frames sent to or from the new VM, and wherein the local VID collides with a second local VID of a second VM attached to the NVE, and receiving a confirmation of a virtual network ID (VNID) for the VM and a new local VID to be used in communicating with the VM, wherein the VNID is globally unique.

In another embodiment, the disclosure includes a method comprising periodically sending a request to a NVE to check an attachment status of a tenant virtual network at the NVE, receiving a second message indicating the tenant virtual network is no longer active; and notifying the NVE to disable a VNID and a VID corresponding to the tenant virtual network.

In yet another embodiment, the disclosure includes a computer program product for managing VIDs, the computer program product comprising computer executable instructions stored on a non-transitory computer readable medium such that when executed by a processor cause a NVE to discover a new VM attached to the NVE, report the new VM to a controller wherein there is a local VID being carried in one or more data frames sent to or from the new VM, and wherein the local VID collides with a second local VID of a second VM attached to the NVE, and receive a confirmation of a VNID for the VM and a new local VID to be used in communicating with the VM, wherein the VNID is globally unique.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a data center network.

FIG. 2 illustrates an embodiment of a server.

FIG. 3 illustrates logical service connectivity for a single tenant.

FIG. 4 illustrates an embodiment of a data center network.

FIG. 5 is a flowchart of an embodiment of a method for managing virtual network identifiers.

FIG. 6 is a flowchart of an embodiment of a method for managing local identifiers in a network virtualization edge (NVE).

FIG. 7 is a schematic diagram of a network device.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Virtual local area networks (VLANs) provide a way for multiple virtual networks to share one physical network (e.g., an Ethernet network). A VLAN may be assigned an identifier (ID), referred to as a “VLAN ID” or in short as “VID”, that is locally unique to the VLAN. Note that the terms VLAN ID and VID may be used herein interchangeably. There may be a fairly small or limited pool of unique VIDs, so the VIDs may be re-used among various VLANs in a data center. As a result of the mobility of VMs (or other entities) within a data center, there may be collisions between VIDs assigned to the various VMs.

Disclosed herein are systems, methods, and apparatuses to allow VMs and other entities to move among various VLANs or other logical groupings in a data center without having collisions between VIDs assigned to the VMs. A protocol is introduced between an edge device and a centralized controller to allow the edge device to request dynamic local VID assignments and be able to release local VIDs that belong to virtual network instances being removed from the edge device.

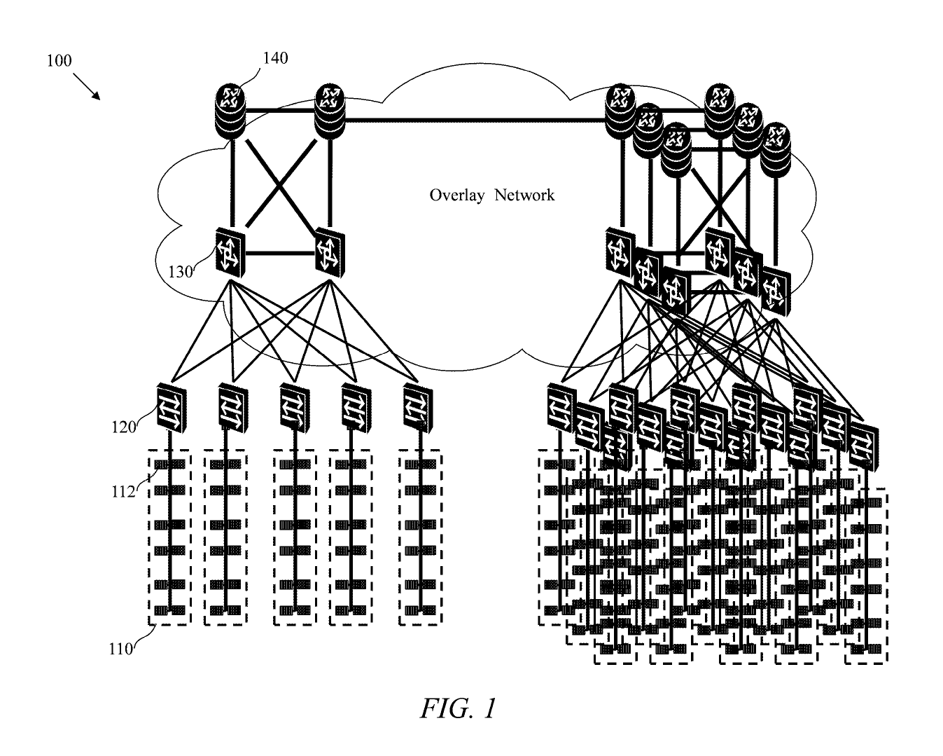

FIG. 1 illustrates an embodiment of a data center (DC) network 100, in which mobility of VMs and other entities may occur. The DC network 100 may use a rack-based architecture, in which multiple equipment or machines (e.g., servers) may be arranged into rack units. For illustrative purposes, one of the racks is shown as rack 110, and one of the machines is shown as a server 112 mounted on the rack 110, as shown in FIG. 1. There may be top of rack (ToR) switches located on racks, e.g., with a ToR switch 120 located on the rack 110. There may also be end of row switches or aggregation switches, such as an aggregation switch 130, each interconnected to multiple ToR switches and routers. A plurality of routers may be used to interconnect other routers and switches. For example, a router 140 may be coupled to other routers and switches including the switch 130.

There may be core switches and/or routers configured to interconnect the DC network 100 with the gateway of another DC or with the Internet. The switches 130 and ToR switches 120 may form an intra-DC network. The router 140 may provide a gateway to another DC or the Internet. The DC network 100 may implement an overlay network and may comprise a large number of racks, servers, switches, and routers. Since each server may host a larger number of applications running on VMs, the network 100 may become fairly complex. Servers in the DC network 100 may host multiple VMs. To facilitate communications among multiple VMs hosted by one physical server (e.g., the server 112), one or more hypervisors may be set up on the server 112.

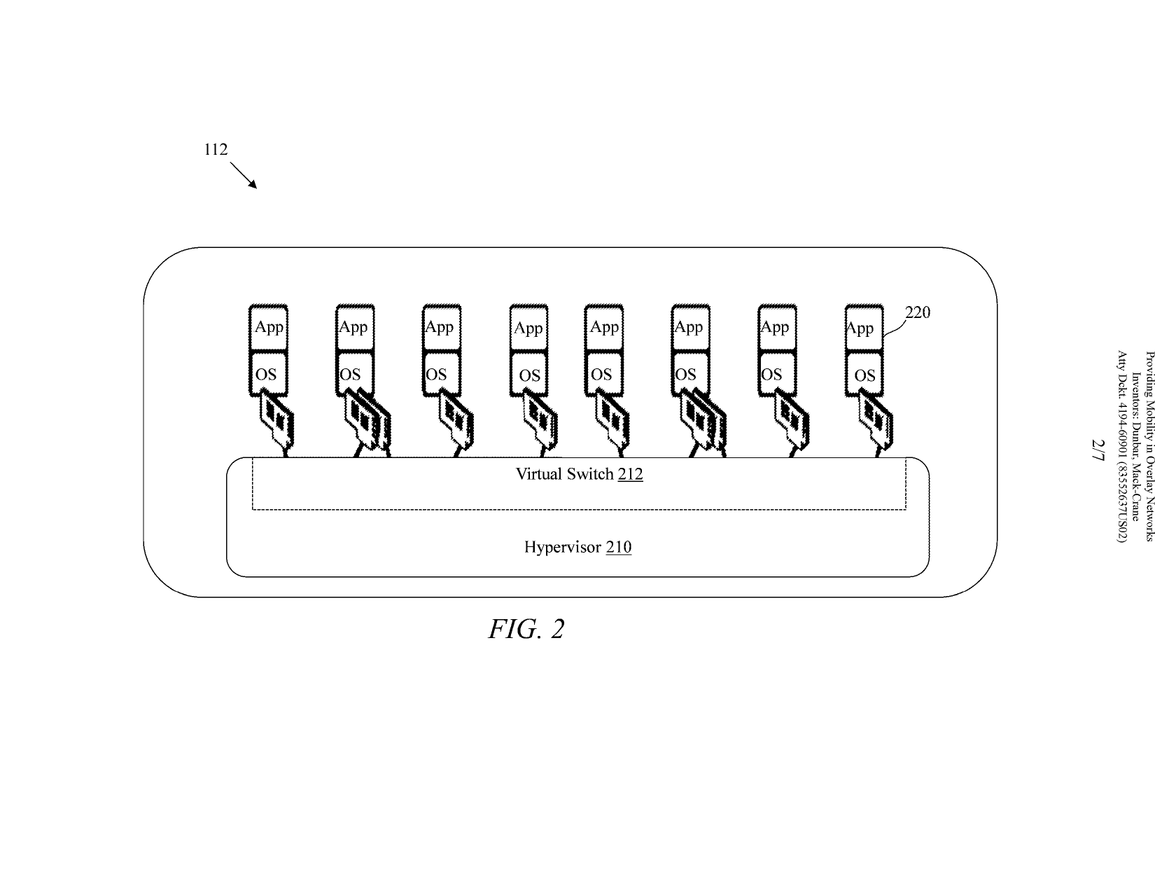

FIG. 2 illustrates an embodiment of the server 112 comprising a hypervisor 210 and a plurality of VMs 220 (one numbered as 220 in FIG. 2) coupled to the hypervisor 210. The hypervisor 210 may be configured to manage the VMs 220, each of which may implement at least one application (denoted as App) running on an operating system (OS). In an embodiment, the hypervisor 210 may comprise a virtual switch (denoted hereafter as vSwitch) 212. The vSwitch 212 may be coupled to the VMs 220 via ports and may provide basic switching function to allow communications among any two of the VMs 220 without exiting the server 112.

Further, to facilitate communications between a VM 220 and an entity outside the server 112, the hypervisor 210 may provide encapsulation function or protocol, such as virtual extensible local area network (VXLAN) and network virtualization over generic routing encapsulation (NVGRE). When forwarding a data frame from a VM 220 to another network node, the hypervisor 210 may encapsulate the data frame by adding an outer header to the data frame. The outer header may comprise an address (e.g., an internet protocol (IP) address) of the server 112, and addresses of the VM 220 may be contained only in an inner header of the data frame. Thus, the addresses of the VM 220 may be hidden from the other network node (e.g., router, switch). Similarly, when forwarding a data from another network to a VM 220, the hypervisor 210 may decapsulate the data frame by removing the outer header and keeping only the inner header.

“Underlay” network is a term sometimes used to describe the actual network that carries the encapsulated data frames. An “underlay” network is very much like the “core” or “backbone” network in the carrier networks. The “Overlay” network and the “Underlay” network are loosely used interchangeably in this disclosure. Sometimes, an “Overlay” network is used in this disclosure to refer to network with many boundary (or edge) nodes which perform encapsulation for data frames so that nodes/links in the middle don't see the addresses of nodes outside the boundary (edge) nodes. The terms “overlay boundary nodes” or “edge nodes” may refer to the nodes which add outer header to data frames to/from hosts outside the core network. Overlay boundary nodes can be virtual switches on hypervisors, ToR switches, or even aggregation switches.

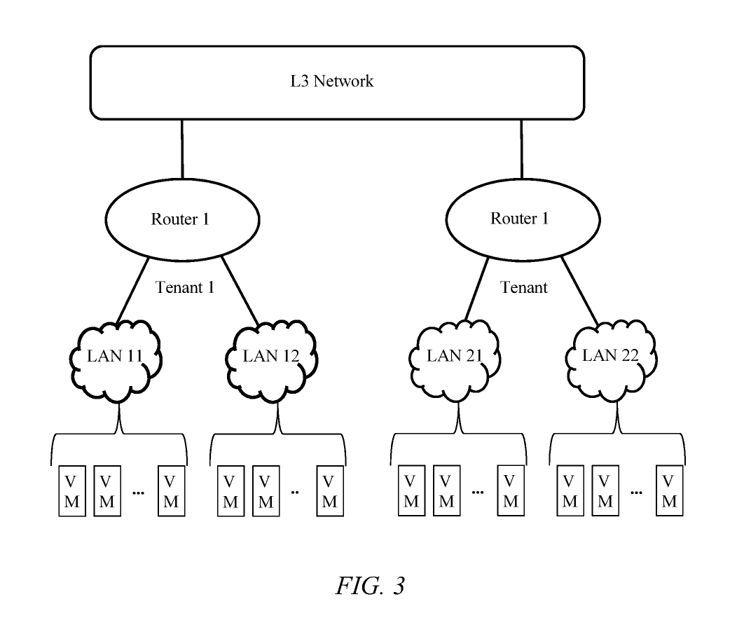

Combining the elements of FIGS. 1 and 2 implies that a DC may comprise a plurality of virtual local area networks (VLANs), each of which may comprise a plurality of VMs, servers, and/or ToR switches, such as VMs 220, servers 112, and/or ToR switches 120, respectively. An overlay network may be considered as a layer 3 (L3) network that connects a plurality of layer 2 (L2) domains. A “tenant” may generally refer to an organizational unit (e.g., a business) that has resources assigned to it in a DC. The resources may be logically or physically separated within the DC. Each tenant may have assigned multiple VLANs, under logical routers. Thus, each tenant may have assigned a plurality of VMs. FIG. 3 illustrates logical service connectivity for a single tenant as discussed above.

An network virtualization edge (NVE) may implement network virtualization functions that allow for L2 and/or L3 tenant separation and for hiding tenant addressing information (media access control (MAC) and IP addresses). An NVE could be implemented as part of a virtual switch within a hypervisor, a physical switch or router, or a network service appliance. Any VMs communicating with peers in different subnets, either within DC or outside DC, will have their L2 MAC address destined towards its local Router. The overlay is intended to make the core (e.g., the underlay network) switches/routers forwarding tables not be impacted when VMs belonging to different tenants are placed or moved to anywhere.

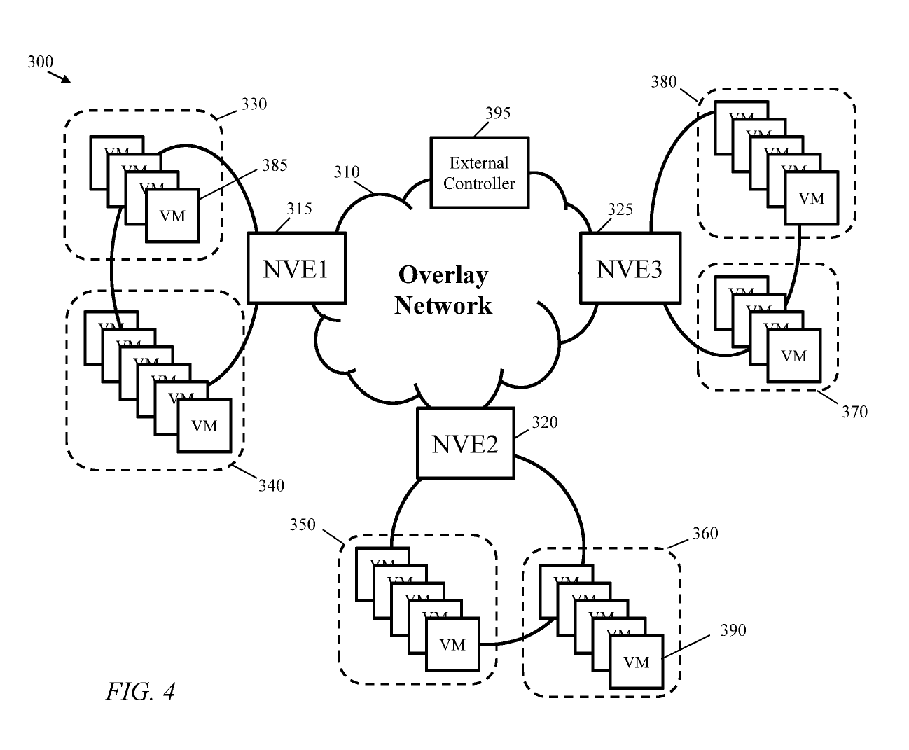

FIG. 4 illustrates an embodiment of a DC network 300. The DC network 300 is illustrated using a combination of logical and structure elements. FIG. 3 reflects a traditional architecture, in which VMs are bound in LANs, while FIG. 4 reflects a virtual architecture, in which VMs can migrate between any two NVEs. The DC network 300 comprises an overlay network 310, network virtualization edge (NVE) nodes (also referred to as overlay edge nodes) NVE1 315, NVE2 320, and NVE3 325, and VLANs 330-380 configured as shown in FIG. 4. The DC network 300 may also optionally comprise an external controller 395 as shown. Each VLAN is coupled to an NVE node. That is, VLANs 330 and 340 are coupled to NVE1 315 as the nearest NVE node, VLANs 350 and 360 are coupled to NVE2 320 as the nearest NVE node, and VLANs 370 and 380 are coupled to NVE3 325 as the nearest NVE node. Although six VLANs are shown in FIG. 4 for illustrative purposes, a DC may comprise any number of VLANs. Similarly, although three NVEs are shown in FIG. 4 for illustrative purposes, a DC may comprise any number of NVEs.

Each of the VLANs 330-380 comprises a plurality of VMs as shown. In general, a VLAN may comprise any number of VMs and may be limited only by the local address space in assigning VIDs to VMs and other entities within a VLAN. For example, if 12-bit Ethernet medium access control (MAC) addresses are used for VIDs, the limit on the number of unique addresses is 4,096.

VMs 385 and 390 are illustrated as exemplary VMs for the purposes of illustrating communication between VMs. For client traffic from VM 385 to VM 390, the ingress NVE (i.e., NVE1 315) encapsulates the client payload with an outer header which includes at least egress NVE as the destination address (DA), ingress NVE as the source address (SA), and a virtual network ID (VNID). The VNID may be represented using a larger number of bits than the number of bits allocated for the VID (i.e., global addresses may have a larger address space than local addresses). The VNID may be a 24-bit identifier as an example, which is large enough to separate tens of thousands of tenant virtual networks. When the egress NVE (i.e., NVE2 320) receives the data frame from its underlay network facing ports, the egress NVE decapsulates the outer header and then forwards the decapsulated data frame to the attached VMs.

If VM 390 is on the same subnet (or VLAN) as VM 385 and located within the same DC, the corresponding egress NVE is usually on a virtual switch in a server, on a ToR switch, or on a blade switch. If VM 390 is on a different subnet (or VLAN), the corresponding egress NVE should be next to (or located on) the logical router on the L2 network, which is most likely located on the data center gateway router(s).

Since the VMs attached to one NVE could belong to different virtual networks, the traffic under each NVE may be identified by local network identifiers, which is usually VLAN if VMs are attached to NVE access ports via L2.

To support tens of thousands of virtual networks, it may be desirable for the local VID associated with client payload under each NVE to be locally significant. If an ingress NVE encapsulates an outer header to data frames received from VMs and forwards the encapsulated data frames to an egress NVE via the underlay network, the egress NVE may not decapsulate the outer header and send the decapsulated data frames to attached VMs, as done, for example by Transparent Interconnection of Lots of Links (TRILL) and Short Path Bridging (SPB). An egress NVE may convert the VID carried in the data frame to a local VID for the virtual network before forwarding the data frame to the VMs attached.

In virtual private LAN service (VPLS), for example, an operator may configure the local VIDs under each provider edge (PE) to specific virtual private network (VPN) instances. In VPLS, the local VID mapping to VPN instance ID may not change very much. In addition, most likely consumer edge (CE) is not shared by multiple tenants, so the VIDs on one physical port of PE to CE are only for one tenant. For rare occasion of multiple tenants sharing one CE, the CE can convert the tuple [local customer VIDs & Tenant Access Port] to the VID designated by VPN operator for each VPN instance on the shared link between CE port and PE port. For example, the VIDs under one CE and the VIDs under another CE can be duplicated as long as the CEs can convert the local VIDs from their downstream links to the VIDs given by the VPN operators for the links between PE and CEs.

When VMs move in a DC, the local VID mapping to global VNID becomes dynamic. In the DC 300 in FIG. 4, for example, the NVE1 315 may have local VIDs numbered 100 through 200 assigned to attached virtual networks (e.g., VLANs 330 and 340). The NVE2 320 may have local VIDs numbered 100 to 150 assigned to different virtual networks (e.g., VLANs 350 and 360). With VNID encoded in the outer header of data frames, the traffic in the overlay network 310 may be strictly separated.

When some VMs associated with a virtual network using VID equal to 120 under NVE1 315 are moved to NVE2 320, a new VID may need to be assigned for the virtual network under NVE2 320.

Note that a local VID carried in a frame from VMs may not be assigned by the corresponding NVE or controller. Instead, the local VID may be tagged by non-NVE devices. If the local VIDs are tagged (i.e., local VIDs embedded in frames or messages) by non-NVE devices (e.g. VMs themselves, blade server switches, or virtual switches within servers), the following procedure may be performed. The devices which add VID to untagged frames may need to be informed of the local VID. If data frames from VMs already have VID encoded in data frames, then there may be a mechanism to notify the first switch port facing the VMs to convert the VID encoded by the VMs to the local VID which is assigned for the virtual network under the new NVE. That means when a VM is moved to a new location, its immediate adjacent switch port has be informed of a local VID to convert the VID encoded in the data frames from the VM.

NVE will need the mapping between local VID and the VNID to be used to face the underlay network (the core network, L3 or others). “Dynamic Virtual Network Configuration Protocol” (DvNCP or DNCP) is the term given to the procedures described herein for managing local VID assignment and dynamic mapping between local VIDs and global VNIDs. The local VID assignment may be managed by an external controller or an NVE.

The architecture in which VIDs are managed by an external controller is discussed first. A data center, such as DC network 300, may comprise an external controller, such as external controller 395, as shown, for example, in FIG. 4 (an external controller may also be referred to as a DvNCP controller or an SDN controller). The VM assignment to a physical location may be managed by a non-networking entity (e.g. VM manager or a server manager). NVEs may not be aware of VMs being added or deleted unless NVEs have a north bound interface to a controller which can communicate with VM and/or server manager(s). If there is an external controller which can be informed of VMs being added/deleted and their associated tenant virtual networks, the following steps are needed to ensure that proper local VIDs are used under the NVEs. An external controller for virtual network (closed user group) management could be structured as a hierarchy of virtual network (e.g., VLAN) authorities (e.g., similar to the systems dynamically providing IP addresses to end systems (or machines) via Dynamic Host Configuration Protocol (DHCP)). An external controller may therefore comprise a plurality of distributed controllers. A plurality of distributed controllers may therefore be used, and no single distributed controller would necessarily have knowledge of or be aware of all virtual networks in a data center. For example, information about the virtual networks in a data center may be partitioned over a plurality of distributed controllers.

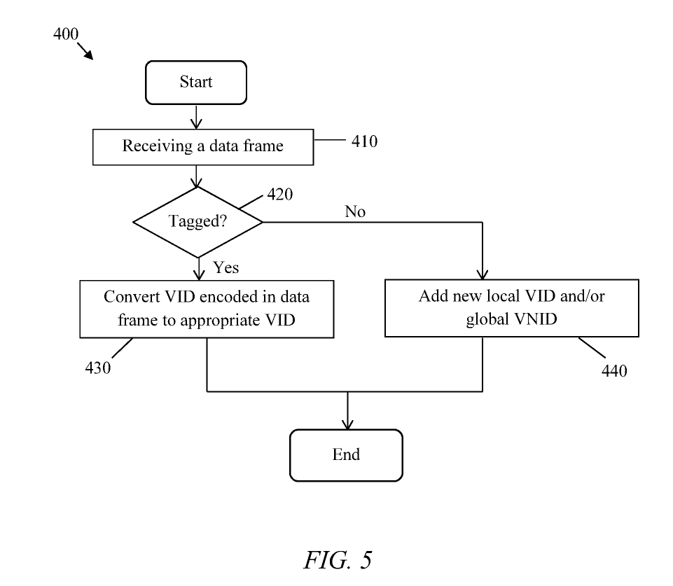

FIG. 5 illustrates a flowchart of a method 400 for managing virtual network identifiers (e.g., VIDs and VNIDs). The flowchart in FIG. 5 is used to help illustrate operation of a DC network comprising an external controller. The method 400 may begin in block 410. In block 410, a data frame may be received by an NVE. The data frame may arrive at a physical or virtual port on the NVE. Next in decision block 420, a determination is made whether the data frame is tagged (i.e., whether the frame has an embedded local VID). If the frame is not tagged, block 440 is performed next. In block 440, the NVE should get the specific VNID from the external controller for untagged data frames. Since local VIDs under each NVE are really locally significant, an ingress NVE should remove the local VID attached to the data frame, so that egress NVE can always assign its own local VID to data frame before sending the decapsulated data frame to attached VMs. If it is desirable to have local VID in the data frames before encapsulating outer header (i.e. Egress NVE-DA (destination address), Ingress NVE-SA (source address), VNID), NVE should get the specific local VID from the external controller for those untagged data frames coming to each Virtual Access Point.

If a determination is made in block 420 that the data frame is already tagged before reaching the NVE port, the controller can inform the first switch port which is responsible for adding VID to untagged data frames of the specific VID to be inserted to data frames. If data frames from VMs are already tagged, in block 430, the first port facing the VMs may be informed by the external controller of the new local VID to replace the VID encoded in the data frames. If data frames from VMs are tagged, the protocol enforces the first port (or virtual port) facing VMs to convert the VID encoded in the data frames from VMs to the appropriate VID derived from a controller. For traffic from an NVE towards VMs, the protocol also enforces the first port (or virtual port) facing VMs to convert VID carried in the data frames to the VID expected from the VMs.

For data frames coming from core towards VMs (i.e. inbound traffic towards VMs), the first switching port facing VMs have to convert the VIDs encoded in the data frames to the VIDs used by VMs.

If the NVE is not directly connected with the first switch port facing VMs and the first switch facing VMs does not have interface to external controller, the NVE may pass the information from the external controller to the first switch. In the IEEE802.1Qbg Virtual Station Interface (VSI) discovery and configuration protocol (VDP) a hypervisor may be required to send a VM profile if a new VM is instantiated.

An external controller may exchange messages with VM managers (e.g., NVEs or hypervisors) periodically to validate active tenant virtual networks under NVEs. For example, the external controller may send a request message (or simply a “request”) to check a status of a tenant virtual network. If confirmation can be received from VM managers (e.g., NVEs or hypervisors) that a particular tenant virtual network is no longer active under an NVE, i.e. all the VMs belonging to a tenant virtual network should have been deleted underneath the NVE, the external controller may notify the NVE to disable the corresponding VID on the network facing port of the NVE. The NVE also may de-activate the local VID which was used for this tenant virtual network.

The external controller should also trigger an NVE to send an address resolution protocol (ARP)/neighbor discovery (ND)-like message to all the VMs attached for the local VID to make sure that there are no VMs under the local VID still attached. If there is a reply to the ARP/ND query, the NVE should inform the external controller. If a discrepancy occurs between VM manager(s) and replies from local VMs, an alarm should be raised. The alarm may be in the form of a message from the NVE to the external controller.

Local VIDs may periodically be freed up underneath an NVE. When an external controller gets confirmation that a tenant virtual network does not have any VMs attached to an NVE, the external controller should inform the NVE to disable the local VID on its (virtual) access ports. The VID is freed for other tenant virtual networks. After the local VID is freed, NVE has to either drop any data frames received with this local VID, or query its controller when a data frame is received with this local VID. A VID may be disabled on a network facing port of an NVE when the NVE does not have any active VMs for the corresponding tenant virtual network.

An external controller, such as external controller 395 in FIG. 4, may need to exchange messages with VM managers periodically to validate active tenant virtual networks under NVEs. If confirmation can be received from VM managers that a particular tenant virtual network is no longer active under an NVE (i.e., all the VMs belonging to a tenant virtual network should have been deleted underneath the NVE), the external controller may need to notify NVE to disable the corresponding NVID on the network facing port of the NVE. The NVE also may need to deactivate the local VID which was used for this tenant virtual network.

The external controller may also trigger the NVE to send an ARP/ND-like message to all the VMs attached for the local VID. This may ensure that there are no attached VMs under the local VID. If there are replies to the ARP/ND query, the NVE may inform the external controller. The external controller should raise an alarm if discrepancies occur between VM managers and replies from local VMs.

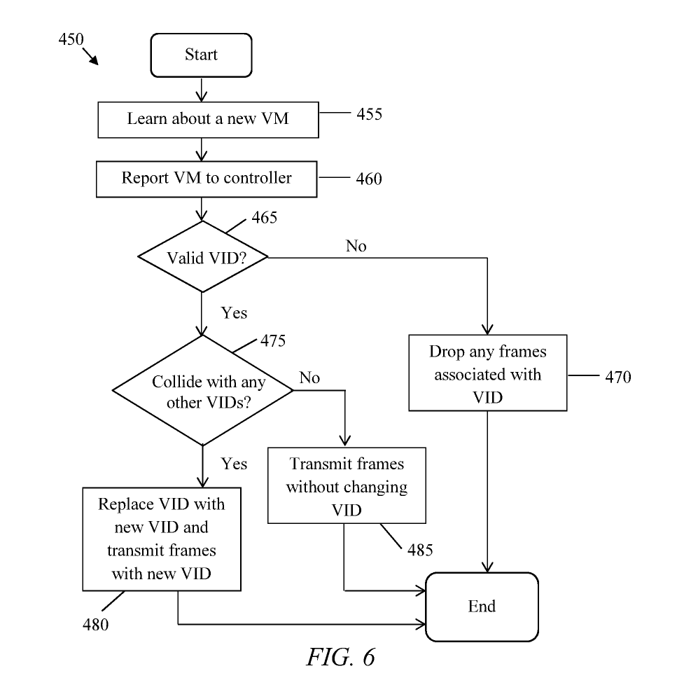

The architecture in which VIDs are managed solely or mainly by an NVE, such as NVEs 315-325, is discussed next. FIG. 6 is a flowchart of an embodiment of a method 450 for managing VIDs in an NVE. The steps of FIG. 6 may be performed in an NVE. The flowchart is used to illustrate management of VIDs. If an NVE does not have an interface to any external controllers which can be informed of VMs being added to or deleted from the NVE, then the NVEs may learn about new VMs being attached, figure out to which tenant virtual network those VMs belong, or age out VMs after a specified timer expires. A network management system may assist the NVE in making the decision, even if the network management system does not have an interface to VM and/or server managers. The network management system may be an entity connected to switches and routers and able to provision for and monitor all the links for the switches and routers.

In block 455, an NVE learns about or discovers a new VM attached to it. A new VM may be identified by a MAC header and/or an IP header and/or other fields in a data frame, such as a TCP port or a UDP port together with source or destination address. If a local VID is tagged by non-NVE devices (e.g. VMs themselves), the first switch port facing VMs may report a new VM being added or disconnected to their corresponding NVE. If an NVE receives a data frame with a new VID which does not have a mapping to global VNID, the NVE may rely on the network management system to determine which VNID is mapped for the newly observed VID. If an NVE receives a data frame with a new VM address (e.g., a MAC address) in a tagged or untagged data frame from its virtual access ports, the new VM could be from an existing local virtual network, from a different virtual network (being brought in as the VM being added in), or from an illegal VM.

Upon an NVE learning about (or discovering) a new VM, for example a VM that has recently been added, either by learning a new MAC address and/or a new IP address, the NVE may report the learned information to its controller, e.g. its network management system, as shown in block 460. A new VM may, for example, automatically send a message to its NVE to announce its presence when the new VM is initiated. A determination may be made whether the new VID is valid as shown in block 465. A controller may help determine the validity and provide an indication of the validity of the new VID and/or new address (the controller may, for example, maintain a list of VMs and their associated VIDs). The controller may also provide the following information to the NVE (if the new VID is valid): (1) the global VNID, and (2) the local VID to be used. This process may be referred to as confirming the legitimacy of the new VM. A confirmation (e.g., a specifically formatted message) may be transmitted to the NVE, wherein the confirmation comprises the global VNID and the local VID to be used. Next in block 470, if the new address or VID is from an invalid or illegal source, the data frame may be dropped.

In decision block 475, a determination is made whether the VID collides with other VIDs in a VLAN or other logical grouping. If there is a collision, next in block 480, if the local VID given by the management system is different from the VID carried in the data frames, NVE uses a mechanism to inform the first switch port facing VMs to either add the specific local VIDs to untagged data frames, or convert the VIDs in the data frames to the specified local VIDs for the virtual network. For environments in which an NVE removes a local VID in data frames before encapsulating the data frames to traverse an underlay network, or the NVE is integrated with the first port facing VMs that send out VLAN tagged data frames, the NVE may remove the VID encoded in the data frames from VMs and use the corresponding VNID derived from an external controller for the outer header. For a reverse traffic direction, i.e. data frames from underlay (core) network towards VMs, the NVE needs to insert the VID expected by VMs to untagged data frames. If there is no collision in block 475, in block 480 data frames may be transmitted without changing the assigned VID.

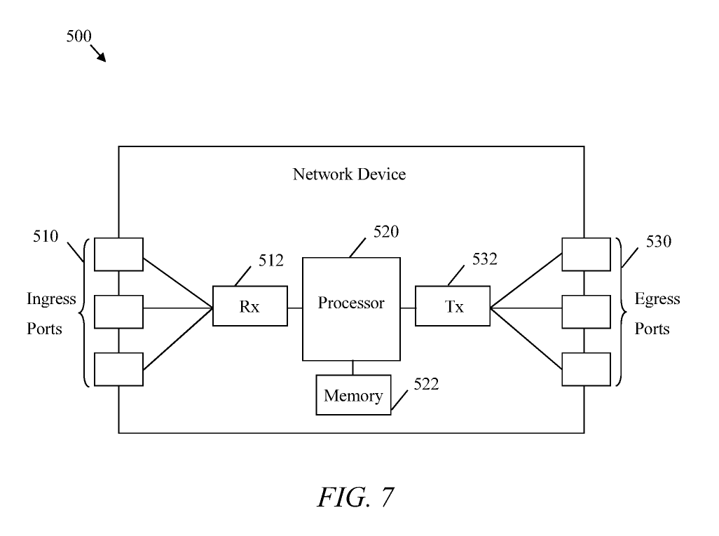

FIG. 7 illustrates an embodiment of a network device or unit 500, which may be any device configured to transport data frames or packets through a network. The network unit 500 may comprise one or more ingress ports 510 coupled to a receiver 512 (Rx), which may be configured for receiving packets or frames, objects, options, and/or Type Length Values (TLVs) from other network components. The network unit 500 may comprise a logic unit or processor 520 coupled to the receiver 512 and configured to process the packets or otherwise determine to which network components to send the packets. The logic unit or processor 520 may be implemented using hardware or a combination of hardware and software. The processor 520 may be implemented as one or more central processor unit (CPU) chips, cores (e.g., a multi-core processor), field-programmable gate arrays (FPGAs), application specific integrated circuits (ASICs), and/or digital signal processors (DSPs). The network unit 500 may further comprise a memory 522. A hypervisor (e.g., the hypervisor 210) may be implemented using a combination of the processor 520 and the memory 522.

The memory 522 may comprise secondary storage, random access memory (RAM), and/or read-only memory (ROM) and/or any other type of storage. The secondary storage may comprise one or more disk drives or tape drives and is used for non-volatile storage of data and as an over-flow data storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

The network unit 500 may also comprise one or more egress ports 530 coupled to a transmitter 532 (Tx), which may be configured for transmitting packets or frames, objects, options, and/or TLVs to other network components. Note that, in practice, there may be bidirectional traffic processed by the network node 500, thus some ports may both receive and transmit packets. In this sense, the ingress ports 510 and the egress ports 530 may be co-located or may be considered different functionalities of the same ports that are coupled to transceivers (Rx/Tx). The processor 520, the receiver 512, and the transmitter 532 may also be configured to implement or support any of the procedures and methods described herein, such as the method for managing virtual network identifiers 400.

It is understood that by programming and/or loading executable instructions onto the network device 500, at least one of the processor 520 and the memory 522 are changed, transforming the network device 500 in part into a particular machine or apparatus, e.g. an overlay edge node or a server (e.g., the server 112) comprising a hypervisor (e.g., the hypervisor 210) which in turn comprises a vSwitch (e.g., the vSwitch 212) or an NVE, such as NVE1 315, or an external controller 395, having the functionality taught by the present disclosure. The executable instructions may be stored on the memory 522 and loaded into the processor 520 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner, as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of managing local identifiers (VIDs) in a network virtualization edge (NVE), the method comprising:
discovering a new virtual machine (VM) attached to the NVE;
reporting the new VM to a controller, wherein there is a local VID being carried in one or more data frames sent to or from the new VM, and wherein the local VID collides with a second local VID of a second VM attached to the NVE; and
receiving a confirmation of a virtual network ID (VNID) for the VM and a new local VID to be used in communicating with the VM, wherein the VNID is globally unique.

2. The method of claim 1, further comprising rejecting, by the controller, the request from the NVE due to the new VM being not legitimate to be attached to the NVE.

3. The method of claim 1, wherein reporting the new VM to a controller comprises sending at least one identifier of the VM to the controller, and wherein the at least one identifier of the VM is a medium access control (MAC) address and/or an internet protocol (IP) address and/or other fields in the data frame sent from the VM.

4. The method of claim 1, further comprising:
receiving a frame from a third VM comprising the local VID;
replacing the local VID with the new local VID in the frame from the third VM;
forwarding the frame to a next node; and
replacing the new local VID in a frame towards the third VM with the local VID expected by the third VM.

5. The method of claim 1, further comprising:
receiving a frame from a third VM comprising the local VID;
removing the local VID in the frame and encapsulating the resulting frame using the VNID to generate an encapsulated frame; and
forwarding the encapsulated frame to a next node.

6. The method of claim 1, further comprising:
notifying a first port or virtual access point facing the third VM to replace the local VID carried in an ingress frame with the new local VID before forwarding to a next node; and
replacing the new VID in an egress frame with the local VID expected by the new VM, wherein the ingress frame is sent from the new VM and the egress frame is destined towards the new VM.

7. The method of claim 1, further comprising:
notifying a first port or virtual access point facing the new VM to add the new local VID to untagged frames sent from the new VM before forwarding to a next node; and
removing the new VID from an egress frame before sending to the new VM.

8. The method of claim 1, further comprising:
receiving a request to check an attachment status of a tenant virtual network to the NVE;
determining that the tenant virtual network is not active at the NVE; and
disabling the local VID corresponding to the tenant virtual network.

9. The method of claim 8, further comprising:
triggering the NVE to send another message to all the virtual machines (VMs) attached to the NVE to ensure that there are no attached VMs belonging to the tenant virtual network.

10. The method of claim 1, further comprising:
receiving an encapsulated data frame from a second NVE, wherein a destination address in an outer header of the encapsulated matches an address of the NVE, wherein the encapsulated data frame comprises the VNID and the local VID;
decapsulating the encapsulated data frame including removing the VNID and replacing the local VID with the new local VID, thereby generating a decapsulated data frame; and
forwarding the decapsulated data frame to a VM attached to the NVE.

11. The method of claim 1, further comprising:
discovering a second new VM attached to the NVE;
reporting the second new VM to the controller, wherein there is a third local VID associated with the second new VM, and wherein the third local VID collides with the second local VID of the second VM attached to the NVE; and
receiving a denial of the third local VID.

12. The method of claim 11, further comprising:
receiving a second frame from the second new VM; and
dropping the second frame in response to receiving the denial of the third local VID.

13. The method of claim 1, further comprising:
receiving, from the controller, a second VNID for any untagged data frames from the new VM attached via a port;
receiving a frame from the new VM via the port;
determining that the frame is untagged;
encapsulating the frame using the second VNID based on the port from which the frame is received; and
transmitting the encapsulated frame to a second NVE.

14. The method of claim 13, further comprising:
receiving an encapsulated data frame from a second NVE, wherein a destination address in an outer header of the encapsulated data frame matches to an address of the NVE, wherein the encapsulated data frame comprises the VNID but its payload is an untagged frame,
decapsulating the encapsulated data frame by removing the VNID to generate a decapsulated data frame; and
forwarding the decapsulated data frame to a VM via the port that is associated with the VNID.

15. A method comprising:
periodically sending a request to a network virtualization edge (NVE) to check an attachment status of a tenant virtual network at the NVE;
receiving a second message indicating the tenant virtual network is no longer active; and
notifying the NVE to disable a virtual network identifier (VNID) and a local identifier (VID) corresponding to the tenant virtual network.

16. The method of claim 15, further comprising:
in response to receiving the second message, triggering the NVE to send a third message to all the virtual machines (VMs) attached to the NVE to ensure that there are no attached VMs belonging to the tenant virtual network.

17. The method of claim 16, wherein the third message is an address resolution protocol (ARP) message for internet protocol version 4 (IPv4) or a neighbor discovery (ND) message for internet protocol version 6 (IPv6).

18. The method of claim 16, further comprising:
receiving an indication that there is at least one VM belonging to an instance of the tenant virtual network; and
raising an alarm due to the indication.

19. The method of claim 15, further comprising:
receiving a report of a new VM from the NVE, wherein a second local VID is associated with the new VM, and wherein the second local VID collides with a third local VID of a second VM attached to the NVE;
confirming the legitimacy of the new VM;
assigning a second VNID and a new VID to the new VM, wherein the second VNID and the new VID are to be used in communicating with the new VM; and
sending a confirmation of the legitimacy of the new VM, wherein the confirmation comprises the second VNID and the new VID.

20. The method of claim 15, wherein the method is performed in a distributed controller, wherein the distributed controller is one of a plurality of distributed controllers, and wherein the distributed controller is the only one of the plurality of distributed controllers that is aware of the tenant virtual network.

21. A computer program product for managing virtual identifiers (VIDs), the computer program product comprising computer executable instructions stored on a non-transitory computer readable medium such that when executed by a processor cause a network virtualization edge (NVE) to:
discover a new virtual machine (VM) attached to the NVE;
report the new VM to a controller wherein there is a local VID being carried in one or more data frames sent to or from the new VM, and wherein the local VID collides with a second local VID of a second VM attached to the NVE; and
receive a confirmation of a virtual network ID (VNID) for the VM and a new local VID to be used in communicating with the VM, wherein the VNID is globally unique.

22. The computer program product of claim 21, wherein reporting the new VM to a controller comprises sending at least one identifier of the VM to the controller, and wherein the at least one identifier of the VM is a medium access control (MAC) address and/or an internet protocol (IP) address and/or other fields in the data frame sent from the VM.

23. The computer program product of claim 21, further comprising instructions that cause the NVE to:
receive a frame from a third VM comprising the local VID;
replace the local VID with the new local VID in the frame from the third VM;
forward the frame to a next node; and
replace the new local VID in a frame towards the third VM with the local VID expected by the third VM.

24. The computer program product of claim 21, further comprising instructions that cause the NVE to:
receive a frame from a third VM comprising the local VID;
remove the local VID in the frame and encapsulating the resulting frame using the VNID to generate an encapsulated frame; and
forward the encapsulated frame to a next node.

25. The computer program product of claim 21, further comprising instructions that cause the NVE to:
notify a first port or virtual access point facing the third VM to replace the local VID carried in an ingress frame with the new local VID before forwarding to a next node; and
replace the new VID in an egress frame with the local VID expected by the new VM, wherein the ingress frame is sent from the new VM and the egress frame is destined towards the new VM.

26. The computer program product of claim 21, further comprising instructions that cause the NVE to:
notify a first port or virtual access point facing the new VM to add the new local VID to untagged frames sent from the new VM before forwarding to a next node; and
remove the new VID from an egress frame before sending to the new VM.

27. The computer program product of claim 21, further comprising instructions that cause the NVE to:
receive a request to check an attachment status of a tenant virtual network to the NVE;
determine that the tenant virtual network is not active at the NVE; and
disable the local VID corresponding to the tenant virtual network.

28. The computer program product of claim 27, further comprising instructions that trigger the NVE to send another message to all the virtual machines (VMs) attached to the NVE to ensure that there are no attached VMs belonging to the tenant virtual network.

29. The computer program product of claim 21, further comprising instructions that cause the NVE to:
receive an encapsulated data frame from a second NVE, wherein a destination address in an outer header of the encapsulated matches an address of the NVE, wherein the encapsulated data frame comprises the VNID and the local VID;
decapsulate the encapsulated data frame including removing the VNID and replacing the local VID with the new local VID, thereby generating a decapsulated data frame; and
forward the decapsulated data frame to a VM attached to the NVE.

30. The computer program product of claim 21, further comprising instructions that cause the NVE to:
discover a second new VM attached to the NVE;
report the second new VM to the controller, wherein there is a third local VID associated with the second new VM, and wherein the third local VID collides with the second local VID of the second VM attached to the NVE; and
receive a denial of the third local VID.

31. The computer program product of claim 30, further comprising instructions that cause the NVE to:
receive a second frame from the second new VM; and
drop the second frame in response to receiving the denial of the third local VID.

32. The computer program product of claim 21, further comprising instructions that cause the NVE to:
receive, from the controller, a second VNID for any untagged data frames from the new VM attached via a port;
receive a frame from the new VM via the port;
determine that the frame is untagged;
encapsulate the frame using the second VNID based on the port from which the frame is received; and
transmit the encapsulated frame to a second NVE.

33. The computer program product of claim 21, further comprising instructions that cause the NVE to:
receive an encapsulated data frame from a second NVE, wherein a destination address in an outer header of the encapsulated data frame matches to an address of the NVE, wherein the encapsulated data frame comprises the VNID but its payload is an untagged frame,
decapsulate the encapsulated data frame by removing the VNID to generate a decapsulated data frame; and
forward the decapsulated data frame to a VM via the port that is associated with the VNID.
